(19) United States
(12) Patent Application Publication
(10) Pub. No.: US 2011/0003028 A1
(43) Pub. Date: Jan. 6, 2011

(54) PACKED MEMBER AND PRODUCTION METHOD THEREOF

(76) Inventors: Atsushi Onogi, Hachioji-shi (JP); Mitsuko Ogaki, Saitama-shi (JP)

Correspondence Address: MILES & STOCKBRIDGE PC, 1751 PINNACLE DRIVE, SUITE 500, MCLEAN, VA, 22102-3833, US

(21) Appl. No.: 12/866,891

(22) PCT Filed: Feb. 18, 2009
(86) PCT No.: PCT/JP2009/053298

§ 371 Date: Aug. 10, 2010

(30) Foreign Application Priority Data
Feb. 18, 2008 (JP) 2008-036714

(51) Int. Cl. B65D 77/02; A23G 4/18; A23G 1/50

(52) U.S. Cl. 426/5; 426/108; 426/411

(57) ABSTRACT

Provided are a food packed member holding sheet-like food in a compact package, that allows an eater to easily take out sheet-like food and easily eat it even when either hand of the eater's is unavailable, and a method of producing the same. The inventive packed member is a packed member of sheet-like food such as chewing gum or chocolate, wherein plural pieces of sheet-like food (1) are wrapped respectively with a wrapping sheet (2) which includes a picking part (4), a fixing part (5), and a fragile part (3) between the both parts, and is openable by cutting the fragile part (3) and taking out the picking part (4), and a sheet-like food unit (1a) formed by joining the plural pieces of wrapped sheet-like food (1) by joining a base sheet (6) at the fixing parts (5) of the wrapping sheets (2) is held while fixed to a packaging container material (7, 31, 41) at the joining base sheet (6), and the inventive production method includes producing the packed member by placing the sheet-like food unit (1a) on a packaging material (7, 31, 41).

### TECHNICAL FIELD

The present invention relates to a packed member that holds sheet-like food such as gum or chocolate, and a method of producing the same.

### BACKGROUND ART

Hitherto, as a packaging container for holding sheet-like food such as gum or chocolate, those described in Japanese Patent No. 3955355 and Japanese Patent No. 3955356 are known.

Packaging containers described in these patent documents realize compact package in a state holding sheet-like food upright in two rows in such a manner that the two rows overlap with each other with the back row being at a higher level than the front row by providing a step therebetween.

According to such a configuration, since the sheet-like food in the back row is at a higher level than that in the front row in the packaging container, it is easy to take out the food. In addition, since the sheet-like food is temporarily attached inside the packaging container, the content in the back row is prevented from being moved, for example, when sheet-like food in the front row is taken out.

Each piece of sheet-like food thus taken out will be eaten after its wrapping paper is peeled off.

The above Japanese Patent No. 3955356 also discloses a method of producing the above packaging container.

### DISCLOSURE OF THE INVENTION

### Problem to be Solved by the Invention

However, in the packaging container described in each of the above patent documents, one must peel the wrapping paper after taking out a piece of sheet-like food to eat, so that he/she will experience difficulty when either hand is unavailable.

According to a method of producing a packaging container described in the above Japanese Patent No. 3955356, it is possible to manufacture a packaging container in an automated line, however, there still remains the problem that one must peel the wrapping paper after taking out a piece of sheet-like food to eat.

Consequently, it is an object of the present invention to provide a food packed member that holds sheet-like food in a compact package, which allows an eater to easily take out sheet-like food and easily eat it even when either hand of the eater's is unavailable, and to provide a method of producing the same.

### Means for Solving the Problem

According to a first aspect of the present invention, there is provided a packed member of sheet-like food such as chewing gum or chocolate, wherein plural pieces of sheet-like food 1 are wrapped respectively with a wrapping sheet 2 which includes a picking part 4, a fixing part 5 and a fragile part 3 between the both parts, and is openable by cutting the fragile part 3 and taking out the picking part 4, and a sheet-like food unit 1a formed by joining the plural pieces of wrapped sheet-like food 1 by joining a base sheet 6 at the fixing parts 5 of the wrapping sheets 2 is held while fixed to a packaging container material 7, 31, 41 at the joining base sheet 6.

According to a second aspect of the present invention, there is provided a packed member, wherein the packaging container material 41 is formed of a base sheet in which a frame plate 10 is formed continuously to a lower edge of a main plate 8 via a bottom plate 9, a lid plate 12 is formed continuously to an upper edge of the main plate 8 via a joining plate 11, a supporting plate 14 is formed continuously to a left edge of the main plate 8 via a side plate 13, and a supporting plate 16 is formed continuously to a right edge of the main plate 8 via a side plate 15, and the sheet-like food unit 1a is held in a holding part 42 surrounded by the main plate 8, the side plates 13, 15, the supporting plates 14, 16, the bottom plate 9, and the frame plate 10 while it is fixed to an inner surface on the bottom plate 9 side of the holding part 42 at the joining base sheet 6.

According to a third aspect of the present invention, there is provided a packed member wherein a tongue-shaped piece 43 is formed continuously to each end of the bottom plate 9 and each of the tongue-shaped pieces 43 is interposed between each of the side plates 13, 15 forming the holding part 42 and the sheet-like food unit 1a.

According to a fourth aspect of the present invention, there is provided a packed member wherein a plurality of sheet-like food units 1a are held in an overlaying manner.

According to a fifth aspect of the present invention, there is provided a packed member, wherein the packaging container material 7 holds the sheet-like food unit 1a in each of holding parts 23, 24, by assembling a base sheet in which a frame plate 10 is continuously formed to a lower edge of a main plate 8 via a bottom plate 9, a lid plate 12 is continuously formed to an upper edge of the main plate 8 via a joining plate 11, a supporting plate 14 is continuously formed to a left edge of the main plate 8 via a side plate 13, a supporting plate 16 is continuously formed to a right edge via a side plate 15, a supporting plate 18 is continuously formed on a left edge of the frame plate 10 via a side plate 17, and a supporting plate 20 is continuously formed on a right edge via a side plate 19, to form a first holding part 23 surrounded by the main plate 8, the side plates 13, 15 and the supporting plates 14, 16, and a second holding part 24 surrounded by the frame plate 10, the side plates 17, 19 and the supporting plates 18, 20; and fixing the sheet-like food units 1a respectively to the supporting plates 14, 16, 18, 20 at the joining base sheet 6.

According to a sixth aspect of the present invention, there is provided a packed member, wherein front and back two rows of the sheet-like food 1 are held in the holding parts 23, 24 by making the main plate 8 and the frame plate 10 stand up with respect to the bottom plate 9 and overlaying the holding parts 23, 24 in the state in which the sheet-like food unit 1a is held in each of the first and the second holding parts 23, 24.

According to a seventh aspect of the present invention, there is provided a packed member, wherein the packaging container material 31 holds the sheet-like food unit 1a in each of holding parts 23, 24, by assembling a base sheet in which a frame plate 10 is continuously formed to a lower edge of a main plate 8 via a bottom plate 9, a lid plate 12 is continuously formed to an upper edge of the main plate 8 via a joining plate 11, a supporting plate 14a is continuously formed to a left edge of the main plate 8 via a side plate 13, a supporting plate 16a is continuously formed to a right edge via a side plate 15, a supporting plate 18a is continuously formed on a left edge of the frame plate 10 via a side plate 17, and a supporting plate 20a is continuously formed on a right edge via a side plate 19, to form a first holding part 23 surrounded by the main plate 8, the side plates 13, 15 and the supporting plates 14a, 16a, and a second holding part 24 surrounded by the frame plate 10, the side plates 17, 19 and the supporting plates 18a, 20a; continuously forming a fixing piece 33 on each of the free end edges of the supporting plates 18a, 20a via a fragile part 32, at an overlaying position with the joining base sheet 6 of the sheet-like food unit 1a held in the holding part 24; and further fixing the sheet-like food unit 1a to each of the supporting plates 14a, 16a, 18a, 20a at the joining base sheet 6.

According to an eighth aspect of the present invention, there is provided a packed member, wherein front and back two rows of the sheet-like food 1 are held in the holding parts 23, 24 in the state that the sheet-like food unit 1a is held in each of the first and the second holding parts 23, 24 by making the main plate 8 and the frame plate 10 stand up with respect to the bottom plate 9 and overlaying the holding parts 23, 24 and fixing the joining base sheet 6 of the sheet-like food unit 1a held in the first holding part 23 with the fixing piece 33 of the second holding part 24 facing therewith.

According to a ninth aspect of the present invention, there is provided a method of producing a packed member (C), including:

(i) an individual wrapping step of individually wrapping each of plural pieces of sheet-like food 1 with a wrapping sheet 2 which includes a picking part 4, a fixing part 5, and a fragile part 3 between the both parts and is openable by cutting the fragile part 3 and taking out the picking part 4;

(ii) an aligning step of aligning the individually wrapped plural pieces of sheet-like food 1 close to each other in their width direction;

(iii) a unit forming step of forming a sheet-like food unit 1a by placing and fixing the joining base sheet 6 on at least one surface of the fixing part 5 of each wrapping sheet 2 of the aligned plural pieces of sheet-like food 1;

(iv) a placing step of placing the sheet-like food unit 1a on a main plate 8 of a packaging container material 41 in which a frame plate 10 is formed continuously to a lower edge of the main plate 8 via a bottom plate 9, a lid plate 12 is formed continuously to an upper edge of the main plate 8 via a joining plate 11, a supporting plate 14 is formed continuously to a left edge of the main plate 8 via a side plate 13, and a supporting plate 16 is formed continuously to a right edge of the main plate 8 via a side plate 15, so that the joining base sheet 6 is positioned on the bottom plate 9 side;

(v) a holding step of surrounding the sheet-like food unit 1a by folding the side plates 13, 15, the supporting plates 14, 16, the bottom plate 9 and the frame plate 10 with respect to the main plate 8, and fixing the frame plate 10 to the supporting plates 14, 16;

(vi) a fixing step of fixing the sheet-like food unit 1a to at least one of the main plate 8, the side plates 13, 15, the supporting plates 14, 16, the bottom plate 9 and the frame plate 10 at the joining base sheet 6; and

(vii) an overlaying step of making the frame plate 10 and the lid plate 12 overlay each other by folding the joining plate 11 and the lid plate 12 with respect to the main plate 8.

According to a tenth aspect of the present invention, there is provided a method of producing a packed member (C), including the steps of: placing a plurality of sheet-like food units 1a on the main plate 8 of the packaging container material 41 in an overlaying manner so that the joining base sheet 6 is positioned on the bottom plate 9 side, and fixing each of the plurality of sheet-like food units 1a to at least one of the main plate 8, the side plates 13, 15, the supporting plates 14, 16, the bottom plate 9, the frame plate 10 and the other sheet-like food unit 1a.

According to an eleventh aspect of the present invention, there is provided a method of producing a packed member (A), including:

(i) an individual wrapping step of individually wrapping each of plural pieces of sheet-like food 1 with a wrapping sheet 2 which includes a picking part 4, a fixing part 5 and a fragile part 3 between the both parts and is openable by cutting the fragile part 3 and taking out the picking part 4;

(ii) an aligning step of aligning the individually wrapped plural pieces of sheet-like food 1 close to each other in their width direction;

(iii) a unit forming step of forming a sheet-like food unit 1a by placing and fixing a joining base sheet 6 on an upper surface of the fixing part 5 of each wrapping sheet 2 of the plural pieces of sheet-like food 1;

(iv) a placing step of placing on a base sheet wherein a first sheet-like food unit 1a is placed on a frame plate 10 of the base sheet of a packaging container material 7 so that the joining base sheet 6 is located on a bottom plate 9 side and a second sheet-like food unit 1a is placed on a main plate 8 of the base sheet of the packaging container material 7 so that the joining base sheet 6 is located on the bottom plate 9 side, the base sheet being configured by continuously forming the frame plate 10 to a lower edge of the main plate 8 via the bottom plate 9, continuously forming a lid plate 12 to an upper edge of the main plate 8 via a joining plate 11, continuously forming a supporting plate 14 to a left edge of the main plate 8 via a side plate 13, continuously forming a supporting plate 16 to a right edge via a side plate 15, forming a supporting plate 18 on a left edge of the frame plate 10 via a side plate 17, and forming a supporting plate 20 on a right edge via a side plate 19;

(v) a fixing step of fixing supporting plates by folding each of the supporting plates 14, 16, 18, 20, and fixing their inner surfaces to an upper surface of the joining base sheet 6 of each of the sheet-like food units 1a on the main plate 8 and the frame plate 10; and

(vi) an overlaying step of overlaying a first holding part 23 formed by being surrounded by the main plate 8, the side plates 13, 15 and the supporting plates 14, 16 and a second holding part 24 formed being surrounded by the frame plate 10, the side plates 17, 19 and the supporting plates 18, 20.

According to a twelfth aspect of the present invention, there is provided a method of producing a packed member (B), including:

(i) an individual wrapping step of individually wrapping each of plural pieces of sheet-like food 1 with a wrapping sheet 2 which includes a picking part 4, a fixing part 5 and a fragile part 3 between the both parts and is openable by cutting the fragile part 3 and taking out the picking part 4;

(ii) an aligning step of aligning the individually wrapped plural pieces of sheet-like food 1 close to each other in their width direction;

(iii) a unit forming step of forming a sheet-like food unit 1a by placing and fixing a joining base sheet 6 on an upper surface of the fixing part 5 of each wrapping sheet 2 of the plural pieces of sheet-like food 1;

(iv) a placing step of placing on a base sheet wherein a first sheet-like food unit 1a is placed on a frame plate 10 of the base sheet of a packaging container material 31 so that the joining base sheet 6 is located on a bottom plate 9 side and a second sheet-like food unit 1a is placed on a main plate 8 of the base sheet of the packaging container material 31 so that the joining base sheet 6 is located on the bottom plate 9 side, the base sheet being configured by continuously forming the frame plate 10 to a lower edge of the main plate 8 via the bottom plate 9, continuously forming a lid plate 12 to an upper edge of the main plate 8 via a joining plate 11, continuously forming a supporting plate 14a to a left edge of the main plate 8 via a side plate 13, continuously forming a supporting plate 16a to a right edge via a side plate 15, forming a supporting plate 18a on a left edge of the frame plate 10 via a side plate 17, forming a supporting plate 20a on a right edge via a side plate 19, and continuously forming a fixing piece 33 on a respective free end edge of each of the supporting plates 18a, 20a via a fragile part 32;

(v) a fixing step of fixing supporting plates by folding each of the supporting plates 14a, 16a, 18a, 20a, and fixing their inner surfaces to an upper surface of the joining base sheet 6 of each of the sheet-like food units 1a on the main plate 8 and the frame plate 10; and

(vi) an overlaying step of overlaying a first holding part 23 formed by being surrounded by the main plate 8, the side plates 13, 15 and the supporting plates 14a, 16a and a second holding part 24 formed by being surrounded by the frame plate 10, the side plates 17, 19 and the supporting plates 18a, 20a, and fixing each fixing piece 33 on the second holding part 24 side and the joining base sheet 6 of the sheet-like food unit 1a held in the first holding part 23 facing therewith.

### Effect of the Invention

According to a packed member of the present invention, it is possible to hold sheet-like food in a compact package and allow an eater to easily take out sheet-like food and easily eat it even when either hand of the eater's is unavailable.

According to a method of producing a packed member of the present invention, it is possible to manufacture the above packed member readily and efficiently.

### BRIEF DESCRIPTION OF THE DRAWINGS

FIG. 1 is a perspective view illustrating producing steps of a packed member in accordance with one example of the present invention.

FIG. 2 is a plan view illustrating a base sheet of a packaging container material and joining base sheets for the packed member.

FIG. 3 is a plan view illustrating a base sheet of a packaging container material of a packed member and joining base sheets in accordance with one example of the present invention.

FIG. 4A is a partial plan view illustrating a state in which sheet-like food pieces each wrapped with a wrapping sheet are supported by a joining base sheet and placed on a base sheet and supporting plates of a holding part are folded.

FIG. 4B is a partial plan view illustrating a state in which overlaying of both holding parts of the packaging container material that is once assembled is released.

FIG. 5 is a perspective view illustrating production steps of a packed member in accordance with one example of the present invention.

FIG. 6 is a plan view illustrating a base sheet of a packaging container material of a packed member in accordance with one example of the present invention.

FIG. 7 is an enlarged perspective view illustrating one example of a packaging form of sheet-like food in the present invention.

FIG. 8 is a perspective view illustrating a state of taking out sheet-like food from a packed member in accordance with the present invention.

### EXPLANATION OF REFERENCE NUMERALS

A, B packed member
1 sheet-like food
1a sheet-like food unit
2 wrapping sheet
3 fragile part
4 picking part
5 fixing part
6 joining base sheet
7 packaging container material
8 main plate
9 bottom plate
10 frame plate
11 joining plate
12 lid plate
13 side plate
14 supporting plate
14a supporting plate
14b notch
15 side plate
16 supporting plate
16a supporting plate
16b notch
17 side plate
18 supporting plate
18a supporting plate
18b notch
19 side plate
20 supporting plate
20a supporting plate
20b notch
21 engaging piece
22 engaging hole
23 holding part
24 holding part
25 base sheet magazine
31 packaging container material
32 fragile part
33 fixing piece
41 packaging container material
42 holding part
43 tongue-shaped piece
44 engaging portion
45 engaging hole
50 overlapped portion

### BEST MODE FOR CARRYING OUT THE INVENTION

One embodiment of the present invention is a packed member sheet-like food such as chewing gum or chocolate, wherein plural pieces of sheet-like food 1 are wrapped respectively with a wrapping sheet 2 which includes a picking part 4, a fixing part 5 and a fragile part 3 between the both parts, and is openable by cutting the fragile part 3 and taking out the picking part 4, and a sheet-like food unit 1a formed by joining the plural pieces of wrapped sheet-like food 1 by joining a base sheet 6 at the fixing parts 5 of the wrapping sheets 2 is held while fixed to a packaging container material 7, 31, 41 at the joining base sheet 6.

Other embodiment of the present invention is a method of producing a packed member (C), including:

(i) an individual wrapping step of individually wrapping each of plural pieces of sheet-like food 1 with a wrapping sheet 2 which includes a picking part 4, a fixing part 5, and a fragile part 3 between the both parts and is openable by cutting the fragile part 3 and taking out the picking part 4;

(ii) an aligning step of aligning the individually wrapped plural pieces of sheet-like food 1 close to each other in their width direction;

(iii) a unit forming step of forming a sheet-like food unit 1a by placing and fixing the joining base sheet 6 on at least one surface of the fixing part 5 of each wrapping sheet 2 of the aligned plural pieces of sheet-like food 1;

(iv) a placing step of placing the sheet-like food unit 1a on a main plate 8 of a packaging container material 41 in which a frame plate 10 is formed continuously to a lower edge of the main plate 8 via a bottom plate 9, a lid plate 12 is formed continuously to an upper edge of the main plate 8 via a joining plate 11, a supporting plate 14 is formed continuously to a left edge of the main plate 8 via a side plate 13, and a supporting plate 16 is formed continuously to a right edge of the main plate 8 via a side plate 15, so that the joining base sheet 6 is positioned on the bottom plate 9 side;

(v) a holding step of surrounding the sheet-like food unit 1a by folding the side plates 13, 15, the supporting plates 14, 16, the bottom plate 9 and the frame plate 10 with respect to the main plate 8, and fixing the frame plate 10 to the supporting plates 14, 16;

(vi) a fixing step of fixing the sheet-like food unit 1a to at least one of the main plate 8, the side plates 13, 15, the supporting plates 14, 16, the bottom plate 9 and the frame plate 10 at the joining base sheet 6; and

(vii) an overlaying step of making the frame plate 10 and the lid plate 12 overlay each other by folding the joining plate 11 and the lid plate 12 with respect to the main plate 8.

### Example 1

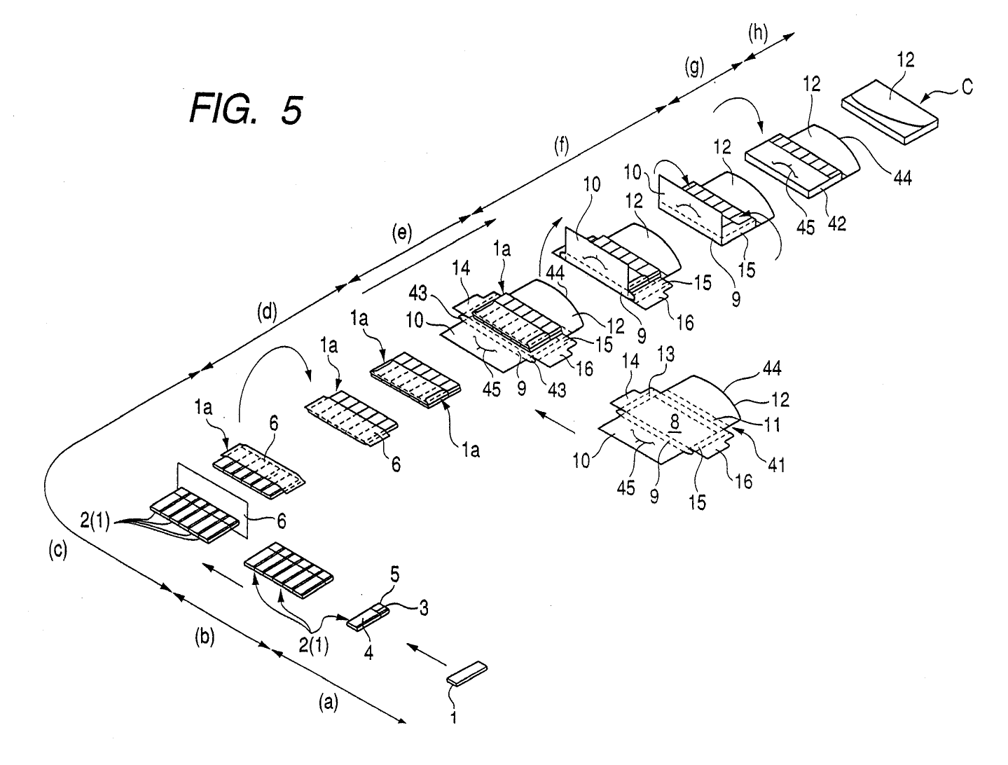

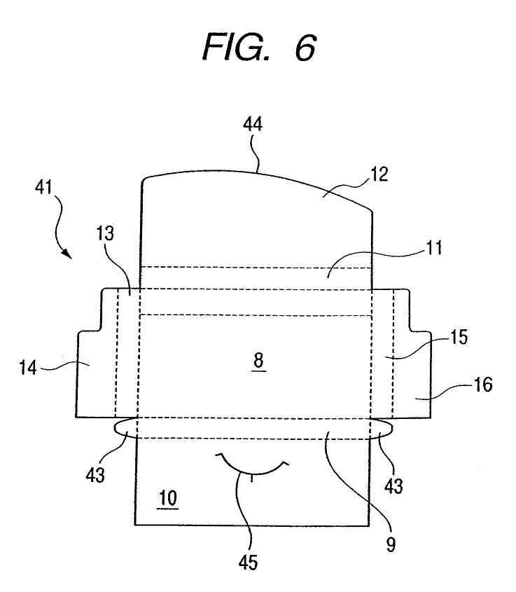

In the following, a packed member C according to Example 1 of the present invention will be described with reference to FIGS. 5 to 8.

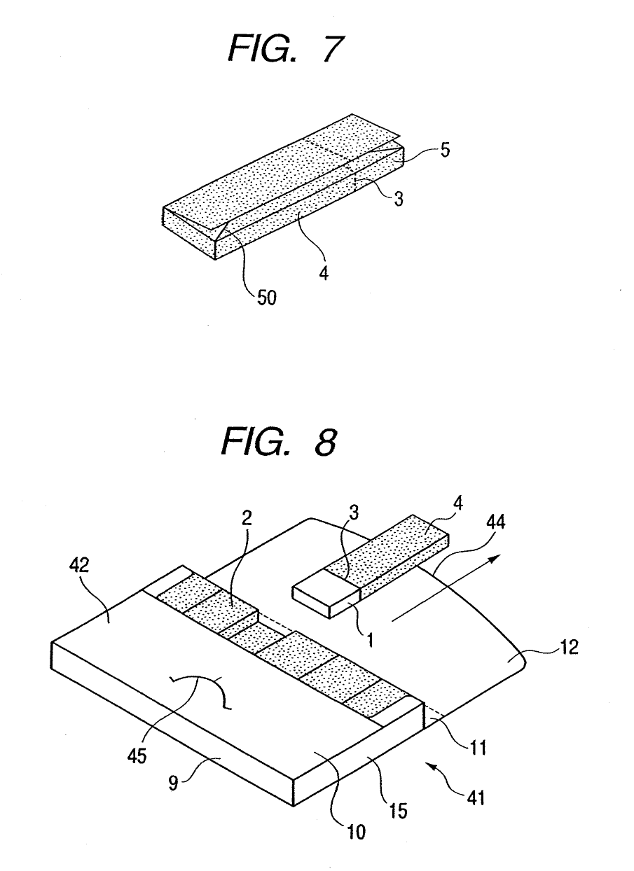

In the figures, reference numeral 1 denotes sheet-like food such as chewing gum or chocolate, reference numeral 2 denotes a wrapping sheet for wrapping the sheet-like food 1 that is made of paper, plastic such as polypropylene, metal such as aluminum or a laminate of two or more kinds of those materials, and wraps the sheet-like food 1 by folding back one side of the wrapping sheet 2 to cover a half on one side in the width direction of the sheet-like food 1, then folding back both ends in the longitudinal direction of the wrapping sheet 2, and finally folding back the other side of the wrapping sheet 2, as shown in FIG. 7, for example. Incidentally, in FIG. 7, the corner portion of the folded part of the wrapping sheet 2 located outside of each end in the longitudinal direction of the sheet-like food 1 when folding back the one side of the wrapping sheet 2 is interfolded obliquely inside the folded part so as not to be seen from outside.

Not limited to the aforementioned procedure, the wrapping procedure may be achieved by wrapping the outer circumference of the sheet-like food 1 in a lateral direction (width direction) and completes wrapping by folding back both ends in its longitudinal direction, for example.

Wrapping with the wrapping sheet 2 in the present invention also implies enclosing sheet-like food 1 into a container made of a thin plastic sheet, for example.

For example, in a position of slightly closer to one end from the center in the longitudinal direction of the wrapping sheet 2, a perforation serving as a fragile part 3 is linearly formed along the width direction of the sheet-like food 1. This enables separation between a fixing part 5 positioned on the one end side, and a picking part 4 positioned on the other end side by breaking the wrapping sheet 2 along the perforation.

The fragile part 3 is not limited to a perforation insofar as it is breakable upon application of a tensile force between the both ends of the wrapping sheet 2, and may have a groove, or a hollow gap and the like form depending on the material, thickness, sectional shape and the like of the wrapping sheet 2. Therefore, for example, when the sheet-like food 1 is enclosed in a plastic container as described above, the fragile part 3 may be formed by providing the plastic sheet constituting the container with a groove, or a hollow gap and the like.

In the figures, reference numeral 6 denotes a rectangular, joining base sheet for joining pieces of sheet-like food 1 into an integrated sheet-like food unit 1a by aligning six pieces of sheet-like food 1 close to each other in their width direction, and by successively fixing the joining base sheet to the surfaces of the fixing parts 5 of the wrapping sheets 2 of the six pieces of the sheet-like food.

In the figures, the reference numeral 41 denotes a packaging container material, and in its base sheet, a frame plate 10 is formed continuously to a lower edge of a main plate 8 via a bottom plate 9, and a lid plate 12 is formed continuously to an upper edge of the main plate 8 via a joining plate 11. At each end of the bottom plate 9, a tongue-shaped piece 43 is continuously formed.

Furthermore, a supporting plate 14 is formed continuously to a left edge of the main plate 8 via a side plate 13, and a supporting plate 16 is formed continuously to a right edge of the main plate 8 via a side plate 15.

In the figures, reference numeral 44 denotes an engaging portion formed by making a center part of a free end edge of the lid plate 12 to protrude, and reference numeral 45 denotes an engaging hole formed by notching the frame plate 10, and these are configured so as to be engageble with each other.

The packaging container material 41 is so configured that a sheet-like food unit 1a is held in a holding part 42 surrounded by the main plate 8, the side plates 13, 15, the supporting plates 14, 16, the bottom plate 9 and the frame plate 10 while the joining base sheet 6 is located on the bottom plate 9. The sheet-like food unit 1a held in the holding part 42 is fixed at one point or two points or more, for example, by a hot-melt adhesive, to the inner surface on the bottom plate 9 side of the holding part 42, specifically to the inner surface on the bottom plate 9 side of at least one of the main plate 8, the side plates 13, 15, the supporting plates 14, 16, the bottom plate 9 and the frame plate 10, at the portion of the joining base sheet 6.

In the present example, the number of pieces of sheet-like food 1 constituting the sheet-like food unit 1a is 6, however, the number may be appropriately changed, and dimensions of the joining base sheet 6 and the packaging container material 41 may be appropriately changed depending on the number of pieces of the sheet-like food 1.

Furthermore, in the present example, the number of the sheet-like food unit 1a is two, this number may also be changed appropriately, and dimensions (widths) of the side plates 13, 15, the bottom plates 9 and the joining plate 11 may also be changed appropriately depending on the number of the sheet-like food unit 1a. This number is preferably about two in consideration of the volume of the food product or portability of the packed member, however, a thinner packed member having better portability holding only one sheet-like food unit may be provided.

The packed member C in accordance with the present example holds the two sheet-like food units 1a in front and back two rows in the holding part 42 that is formed by standing up the side plates 13, 15 and the bottom plate 9 with respect to the main plate 8, and folding the supporting plates 14, 16 and the frame plate 10 with respect to the side plates 13, 15 and the bottom plate 9, respectively, followed by fixing with an adhesive or the like, in the condition that the two sheet-like food units 1a are placed on the main plate 8 in an overlying manner with the joining base sheets 6 being located on the bottom plate 9 side.

Furthermore, from that condition, the lid plate 12 is folded, and the engaging portion 44 is brought into engagement with the engaging hole 45 to complete lid closure.

Since this packed member C has a compact thin plate form holding the two rows of the sheet-like food 1 in an overlying manner, it is possible to reduce the cost of the packaging material.

Fixation of each part described above may be achieved by adhesion by means of an adhesive or an adhesive material such as adhesive tape, and the like, or by fusion bonding.

In eating the sheet-like food 1, the engaging portion and the engaging hole 45 are released from the engagement and the lid plate 12 is opened, and an upper part of the wrapping sheet 2 with which the sheet-like food 1 is wrapped is picked and pulled to break the wrapping sheet 2 along the fragile part 3, as shown in FIG. 8, and the picking part 4 is pulled out.

As a result, the part of the sheet-like food 1 having located inside the fixing part 5 of the wrapping sheet 2 is exposed, so that one can easily take out and easily eat the food by picking up the part with his/her hand or directly holding in his/her mouth. Therefore, even when either hand of the eater is unavailable, he/she can easily take out and eat easily by holding the food directly in his/her mouth.

As described above, the packed member C in accordance with the present example not only realizes a compact thin plate form that is convenient for carrying in a closed state in a pocket or a bag, but also avoids the trouble that the food scatters inside the pocket or the bag during carrying because for each piece of sheet-like food 1, the fixing part 5 of the wrapping sheet 2 is fixed with respect to the packaging container material 41 via the joining base sheet 6 and the lid is completely closed by the lid plate 12.

Also the sheet-like food 1 can be taken out very easily and rapidly because a part of the food can be readily exposed by breaking the wrapping sheet 2 along the fragile part 3.

Next, one example of a method of producing the packed member C in a production line will be described in the sequence of steps.

### (Individual Wrapping Step)

Each of plural pieces of the sheet-like food 1 is wrapped individually with the wrapping sheet 2 (Step (a) in FIG. 5).

### (Aligning Step)

Individually wrapped six pieces of the sheet-like food 1 are aligned close to each other in their width direction (Step (b) in FIG. 5).

### (Unit Forming Step)

On the upper surface and lower surface of the fixing parts 5 of the wrapping sheets 2 of the adjacently aligned six pieces of sheet-like food 1, one rectangular, joining base sheet 6 is fixed by a hot-melt adhesive or the like while it is continuously abutted with the six pieces of sheet-like food 1 while it is in a state folded along its longitudinal center line, to form a sheet-like food unit 1a in which about ½ length part on the fixing part 5 side of the longitudinal direction of each wrapping sheet 2 is covered on the both surfaces with the joining base sheet 6 (Step (c) in FIG. 5). This fixation may be conducted on both or either one of the upper and lower surfaces of the fixing parts 5 depending on the desired fixation strength and the like. Such as the joining base sheet 6, paper, plastic film, metal foil or composite sheet of two or more kinds of these materials, and the like may be used. For example, aluminum band paper formed by laminating aluminum foil and paper is preferred because it facilitates handling in the subsequent production steps because of having high shape maintainability due to the rigidity of the aluminum foil and it allows easy transmission of the heat of an adhesion heater to a hot-melt adhesive due to high heat conductivity of aluminum. In the illustrated example, the both ends of the joining base sheet 6 continuously fixed on the both surfaces of the fixing parts 5 of the respective wrapping sheets 2 protrude outside from the both ends in the width direction of the connected six pieces of sheet-like food 1. This contributes to reinforcing the holding of the respective wrapping sheets 2 by the joining base sheet 6 by folding back the protruding parts inside, and facilitating handling of the sheet-like food unit 1a, for example, in the subsequent overlaying step of the sheet-like food units 1a. Therefore, when such reinforcement is no longer required, for example, by using a cardboard or the like as the joining base sheet 6, the above protruding part may not be formed.

### (Conveying Step)

A sheet-like food unit 1a is rotated by 180° in the horizontal direction (reversed or turned over) while it is conveyed, and two sheet-like food units 1a are overlaid each other in the same orientation in the state that their extending parts are respectively folded inside (Step (d) in FIG. 5). At this time, the joining base sheets 6 of the sheet-like food units may be either fixed or not fixed with each other. The above reversing (turning over) operation is conducted from the view point of improving the appearance so that the overlapped portion 50 of the wrapping sheet 2 formed in wrapping the sheet-like food 1 with the wrapping sheet 2 will not appear in the front, in the state that the sheet-like food units 1a are held in the holding part 42, and may be omitted as needed.

### (On Base Sheet Placing Step)

The two sheet-like food units 1a stacked are placed on the main plate 8 of the base sheet of the aforementioned packaging container material 41 in such an orientation that the joining base sheets 6 are located on the bottom plate 9 side, and the lower sheet-like food unit 1a is fixed to the main plate 8 (Step (e) in FIG. 5).

### (Supporting Plate Fixing Step)

The bottom plate 9 is folded at the boundary with the main plate 8, then each of the tongue-shaped pieces 43 is folded with respect to the bottom plate 9, the side plates 13, 15 are respectively folded at their boundaries with the main plate 8 so that they cover the respective tongue-shaped pieces 43, the supporting plates 14, 16 are folded at their boundaries with the side plates 13, 15, and their inner surfaces are fixed on the upper surface of the joining base sheet 6 of the upper sheet-like food unit 1a placed on the main plate 8 by an adhesive or the like (Step (f) in FIG. 5). The tongue-shaped piece 43 is provided for preventing a gap from being formed between each of the side plates 13, 15 and the bottom plate 9 when the holding part is formed. This is preferably provided from the viewpoints such as appearance improvement, sanitation requirement, and keeping of mechanical strength of the holding part 42, however it may be omitted. As for the shape, dimension and the like of each of the supporting plates 14, 16, the part of about a half thereof on the bottom plate 9 side in the longitudinal direction, that is overlaid on the joining base sheet 6 of the upper sheet-like food unit 1a should have a width that is able to ensure sufficient fixation with the joining base sheet 6 and the frame plate 10. However, since a remaining part of about half length on the joining plate 11 side in each of the supporting plates 14, 16 is not provided for fixation, the part is made to have a smaller width so that it will not interfere when picking up each piece of sheet-like food 1, in particular, each piece of sheet-like food 1 located on the both ends of the sheet-like food unit 1a from the completed packed member. While this part may not be provided, it is preferred to provide it from the view points such as appearance improvement, sanitation requirement, and keeping of mechanical strength of packed member.

### (Overlaying Step)

The frame plate 10 is folded with respect to the bottom plate 9, and the both ends of the frame plate 10 are respectively fixed to the supporting plates 14, 16 fixed on the joining base sheet 6 of the sheet-like food unit 1a by an adhesive or the like (Step (g) in FIG. 5). The length in the direction along the longitudinal direction of sheet-like food of the frame plate 10 is such a length that is able to keep good appearance by making the joining base sheet 6 invisible from outside when fixed as described above, and will not interfere with picking up of the sheet-like food 1.

### (Folding/Overlaying Step)

The lid plate 12 is overlaid on the frame plate 10 by folding the joining plate 11 with respect to the main plate 8, and folding the lid plate 12 with respect to the joining plate 11 (Step (h) in FIG. 5).

According to the aforementioned production method of the packed member C, it is possible to practice with low cost because the steps are simple, and to securely hold the sheet-like food 1 in the packaging container material 41 without being scattered.

### Example 2

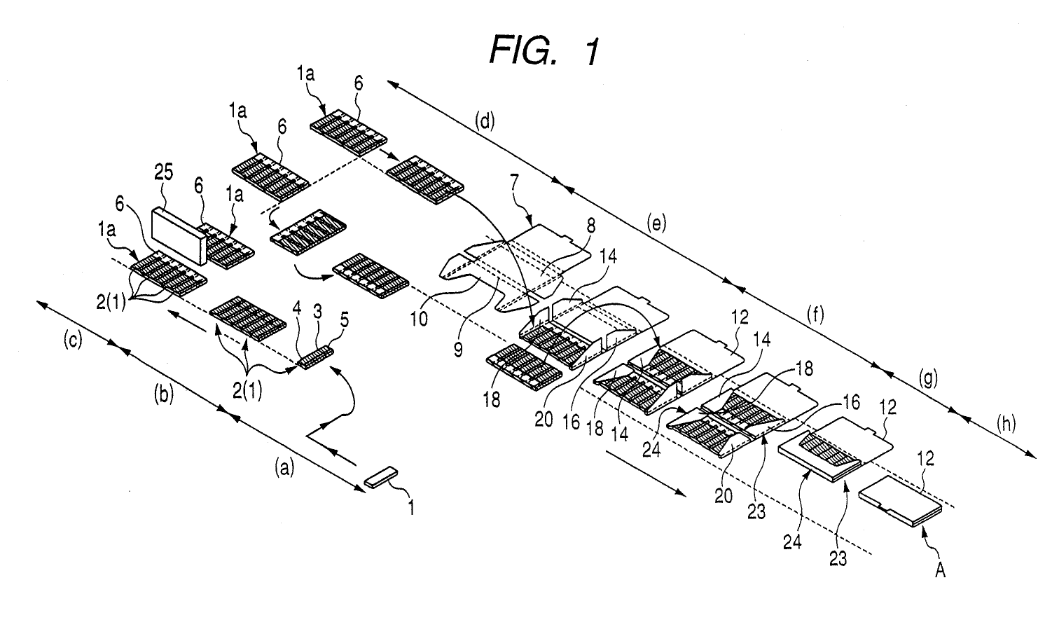

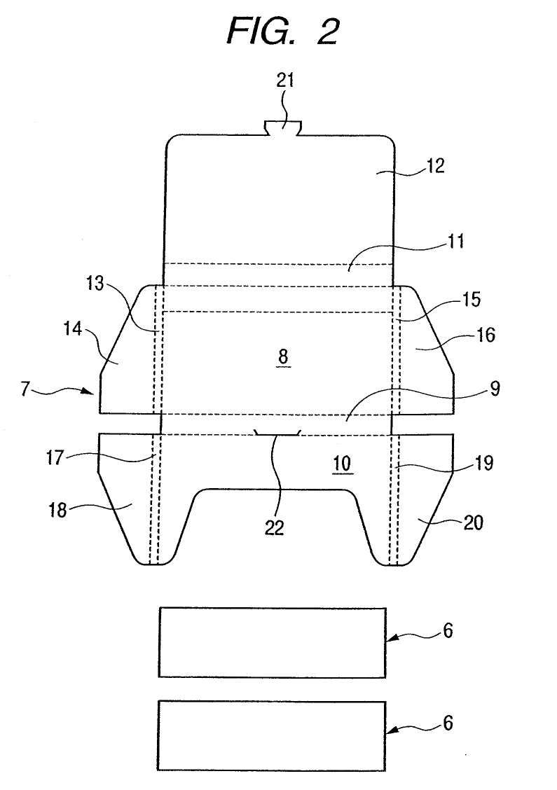

A packed member A in accordance with Example 2 of the present invention will be described with reference to FIGS. 1 and 2. In the figures, the elements which are the same as those shown in Example 1 and FIGS. 5 to 8 are identified by like numerals.

In the figures, reference numeral 1 denotes sheet-like food which is the same as that in Example 1, and reference numerals 2 denotes a wrapping sheet which is the same as that in Example 1.

In the wrapping sheet 2, a perforation serving as the fragile part 3 which is the same as that in Example 1 is formed.

In the figures, reference numeral 6 denotes a rectangular, joining base sheet for joining pieces of sheet-like food 1 into an integrated sheet-like food unit 1a by aligning six pieces of sheet-like food 1 close to each other in their width direction, and by successively fixing the joining base sheet to the surfaces of the fixing parts 5 of the respective wrapping sheets 2 of the six pieces of the sheet-like food.

In the figure, reference numeral 7 denotes a packaging container material, and in its base sheet, a frame plate 10 is continuously formed to a lower edge of a main plate 8 via a bottom plate 9, and a lid plate 12 is continuously formed to an upper edge of the main plate 8 via a joining plate 11.

On a left edge of the main plate 8, a supporting plate 14 is continuously formed via a side plate 13, and on a right edge, a supporting plate 16 is continuously formed via a side plate 15.

Furthermore, on a left edge of the frame plate 10, a supporting plate 18 is continuously formed via a side plate 17, and on a right edge, a supporting plate 20 is continuously formed via a side plate 19.

In the figures, reference numeral 21 denotes an engaging piece provided on a free end edge of the lid plate 12 in a protruding manner, reference numeral 22 denotes an engaging hole formed by forming a notch between the bottom plate 9 and the frame plate 10, and these are configured to be engageable with each other.

The packaging container material 7 is so configured that a first sheet-like food unit 1a is held in a first holding part 23 formed by being surrounded by the main plate 8, the side plates 13, 15 and the supporting plates 14, 16 and a second sheet-like food unit 1a is held in a second holding part 24 formed by being surrounded by the frame plate 10, the side plate 17, 19 and the supporting plates 18, 20. The sheet-like food units 1a respectively held in the holding parts 23, 24 are fixed to inner surface of the folded supporting plates 14, 16, 18, 20 at the position of the joining base sheet 6.

Here, also in the present example, the number of pieces of sheet-like food 1 constituting the sheet-like food unit 1a is 6, however, the number may be appropriately varied, and dimensions of the joining base sheet 6 and the packaging container material 7 may be appropriately varied depending on the number of pieces of sheet-like food 1.

The packed member A in accordance with the present example holds the sheet-like food 1 in front and back two rows in the holding parts 23, 24 that are united by making the main plate 8 and the frame plate 10 stand up with respect to the bottom plate 9, folding both of the holding parts 23, 24 to make them overlaid, and fixing the outer surfaces of the supporting plates 14, 16 on the first holding part 23 side and the outer surfaces of the supporting plates 18, 20 on the second holding part 24 side which are to be opposed to each other by means of an adhesive or the like in the state that each of the first and second holding parts 23, 24 holds the sheet-like food unit 1a.

In the present example, the supporting plates 14, 16 and the supporting plates 18, 20 may not be mutually adhered.

Furthermore, in this state, the lid plate 12 is folded in, and the engaging piece 21 is engaged with the engaging hole 22 to close the lid.

Since this packed member A has a compact thin plate form holding two rows of sheet-like food 1 in an overlying manner, it is possible to reduce the cost of packaging material.

Fixation of each part as described above may be achieved by adhesion by means of an adhesive or an adhesive material such as adhesive tape, or by fusion bonding.

In eating the sheet-like food 1, as described in Example 1, the engaging piece 21 and the engaging hole 22 are released from the engagement to open the lid plate 12, and an upper part of the wrapping sheet 2 that wraps each pieces of the sheet-like food is picked and pulled to break the wrapping sheet 2 along the fragile part 3, and the picking part 4 is pulled out.

As a result, an upper part of the sheet-like food 1 is exposed, so that an eater can easily take out and easily eat it by picking up with his/her hand or directly holding it in his/her mouth. Therefore, for example, even when either hand of the eater is unavailable, he/she can easily take out and eat easily by holding the food directly in his/her mouth.

As described above, the packed member A according to the present example, not only realizes a compact thin plate form that is convenient for carry in a closed state in a pocket or bag, but also avoids the trouble that the food scatters inside the pocket or bag during carry because each piece of sheet-like food 1 is fixed with respect to the packaging container material 7 via the joining base sheet 6 and the lid is closed by the lid plate 12.

Also the sheet-like food 1 can be taken out very easily and rapidly because a top part of the food can be readily exposed by cutting the wrapping sheet 2 along the fragile part 3.

Next, one example of a method of producing the packed member A in a production line will be described in the sequence of steps.

### (Individual Wrapping Step)

Each of plural pieces of the sheet-like food 1 is wrapped individually with the wrapping sheet 2 (Step (a) in FIG. 1).

### (Aligning Step)

Individually wrapped six pieces of the sheet-like food 1 are aligned close to each other in their width direction (Step (b) in FIG. 1).

### (Unit Forming Step)

The joining base sheet 6 is successively placed on the upper surfaces of the fixing parts 5 of the respective wrapping sheets 2 of the closely aligned six pieces of the sheet-like food 1 and fixed by an adhesive or the like, to form the sheet-like food unit 1a (Step (c) in FIG. 1). In the figures, reference numeral 25 denotes a base sheet magazine for supplying the joining base sheet 6.

### (Conveying Step)

While conveying a pair of sheet-like food units 1a in parallel in two lines, one of the pair is rotated by 180° in the horizontal direction so that it is oriented in a direction opposite to that of the other of the sheet-like food unit 1a (Step (d) in FIG. 1).

### (On Base Sheet Placing Step 1)

On the frame plate 10 of the base sheet of the packaging container material 7 which is being conveyed separately, the sheet-like food unit 1a in one of the rows that are being conveyed in a state of two lines is placed in such an orientation that the joining base sheet 6 is located on the bottom plate 9 side. The side plates 13, 15, 17, 19 of the base sheet are caused to stand up on their boundaries with the main plate 8 and the frame plate 10 together with the supporting plates 14, 16, 18, 20 (Step (e) in FIG. 1).

### (On Base Sheet Placing Step 2)

Then, the sheet-like food unit 1a that is being conveyed in other line is placed on the main plate 8 of the base sheet of the packaging container material 7 in such an orientation that the joining base sheet 6 is located on the bottom plate 9 side.

### (Supporting Plate Fixing Step)

The supporting plates 14, 16, 18, 20 are folded at respective boundaries with the side plates 13, 15, 17, 19, and their inner surfaces are fixed to the upper surface of the joining base sheet 6 of each sheet-like food unit 1a placed on the main plate 8 and the frame plate 10 by means of an adhesive or the like (Step (f) in FIG. 1).

### (Overlaying Step)

The holding part 24 is folded and overlaid on the holding part 23, and the supporting plate 18 and the supporting plate 14, and the supporting plate 20 and the supporting plate 16 that are opposite to each other are respectively fixed by an adhesive or the like as needed (Step (g) in FIG. 1).

### (Folding/Overlaying Step)

The lid plate 12 is overlaid on the frame plate 10 by folding the joining plate 11 with respect to the main plate 8, and folding the lid plate 12 with respect to the joining plate 11 (Step (h) in FIG. 1).

According to the aforementioned production method of the packed member A, it is possible to practice with low cost because the steps are simple, and to securely hold the sheet-like food 1 in the packaging container material 7 without being scattered.

### Example 3

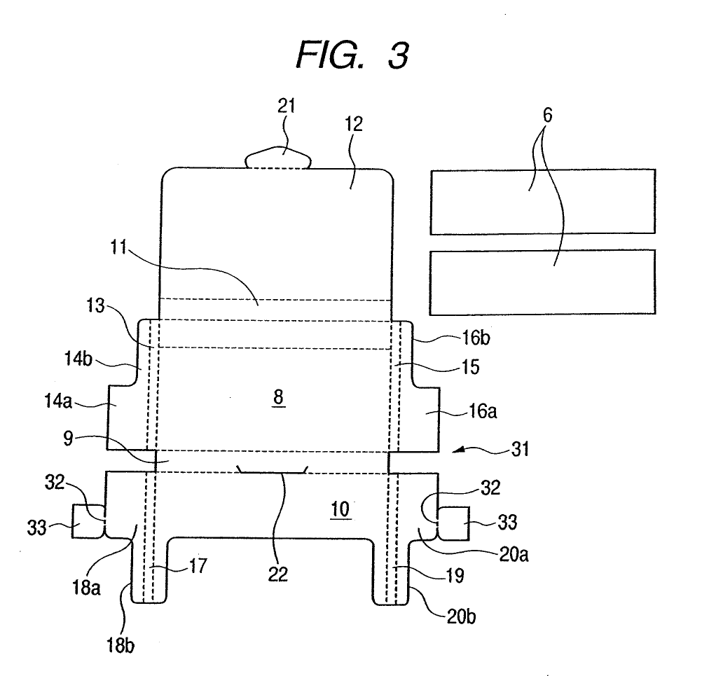

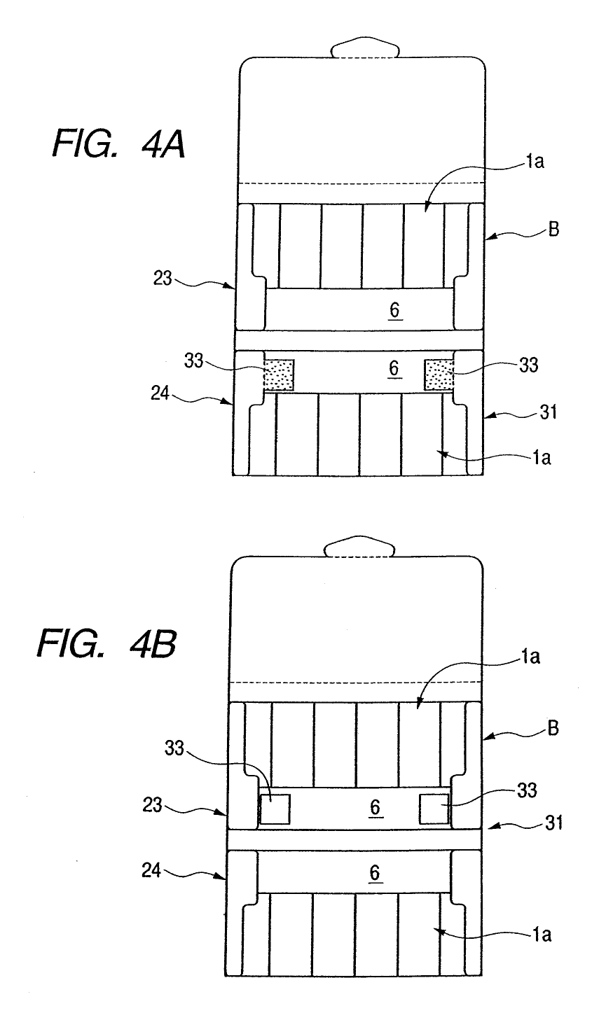

A packed member B in accordance with the present example which is different from the packed member A in accordance with Example 2 in the shape of the packaging container material will be described with reference to FIGS. 3, 4A and 4B.

Since the significant difference of the packaging container material 31 from the packaging container material in accordance with Example 2 is the shape of the supporting plates, the elements which are the same as those shown in the packaging container material 7 in Example 2 and FIGS. 1 and 2 are identified by like numerals.

Supporting plates 14a, 16a, 18a, 20a of the base sheet of the packaging container material 31 are respectively formed in their upper parts with notches 14b, 16b, 18b, 20b. At a free end edge of each of the supporting plates 18a, 20a, a fixing piece 33 is continuously formed via a fragile part 32 in a position where it is overlaid on the joining base sheet 6 of the sheet-like food unit 1a held in the second holding part 24.

In producing this packaging container material 31, two sheet-like food units 1a are held in the holding parts 23, 24, respectively in a similar producing step as that of the packaging container material 7 in Example 2.

A difference from the producing step for the packed member A in Example 2 lies in that an upper surface of each fixing piece 33 is fixed to the joining base sheet 6 of the sheet-like food unit 1a held in the holding part 23 rather than fixing the supporting plates 18a, 20a to the supporting plates 14a, 16a facing therewith, when the holding part 23 and the holding part 24 are folded and overlaid in the overlaying step.

Through the folding/overlaying step as with the production step of Example 1, the packed member B takes the state that two rows of sheet-like food 1 are held in the holding parts 23, 24 in an overlying manner.

Advantages of the packed member B over the packed member A in accordance with Example 2 are as follows.

In brief, in the packed member B, since overlying state of the holding parts 23, 24 is kept by adhesion between the fixing piece 33 and the joining base sheet 6 on the first holding part 23 side, when the holding part 23 and the holding part 24 that are once fixed and overlaid are opened again, the fixing piece 33 is cut at the fragile part 32, and remains fixed on the joining base sheet 6 on the first holding part 23 side. Therefore, marks of removal of adhesive or the like will not be left on the opposing surfaces of the holding parts 23, 24 (FIG. 4B).

Therefore, cleanliness and freshness are maintained while appearance of the packaging container material 31 is not degraded when the overlaid storage parts 23, 24 are opened and the sheet-like food 1 is taken out.

This application claims priority from the Japanese Patent Application No. 2008-036714, filed on Feb. 18, 2008, the contents of which is incorporated by citation herein.

1. A packed member of sheet-like food such as chewing gum or chocolate, wherein plural pieces of sheet-like food are wrapped respectively with a wrapping sheet which comprises a picking part, a fixing part, and a fragile part between the both parts, and is openable by cutting the fragile part and taking out the picking part, and a sheet-like food unit formed by joining the plural pieces of wrapped sheet-like food by joining a base sheet at the fixing parts of the wrapping sheets is held while fixed to a packaging container material at the joining base sheet.

2. The packed member according to claim 1, wherein the packaging container material is formed of a base sheet in which a frame plate is formed continuously to a lower edge of a main plate via a bottom plate, a lid plate is formed continuously to an upper edge of the main plate via a joining plate, a supporting plate is formed continuously to a left edge of the main plate via a side plate, and a supporting plate is formed continuously to a right edge of the main plate via a side plate, and the sheet-like food unit is held in a holding part surrounded by the main plate, the side plates the supporting plates, the bottom plate, and the frame plate while it is fixed to an inner surface on the bottom plate side of the holding part at the joining base sheet.

3. The packed member according to claim 2, wherein a tongue-shaped piece is formed continuously to each end of the bottom plate and each of the tongue-shaped pieces is interposed between each of the side plates forming the holding part and the sheet-like food unit.

4. The packed member according to claim 1, wherein a plurality of sheet-like food units are held in an overlaying manner.

5. The packed member according to claim 1, wherein the packaging container material holds the sheet-like food unit in each of holding parts, by assembling a base sheet in which a frame plate is continuously formed to a lower edge of a main plate via a bottom plate, a lid plate is continuously formed to an upper edge of the main plate via a joining plate, a supporting plate is continuously formed to a left edge of the main plate via a side plate, a supporting plate is continuously formed to a right edge via a side plate, a supporting plate is continuously formed on a left edge of the frame plate via a side plate, and a supporting plate is continuously formed on a right edge via a side plate, to form a first holding part surrounded by the main plate, the side plates and the supporting plates, and a second holding part surrounded by the frame plate, the side plates and the supporting plates; and fixing the sheet-like food units respectively to the supporting plates at the joining base sheet.

6. The packed member according to claim 5, wherein front and back two rows of the sheet-like food are held in the holding parts by making the main plate and the frame plate stand up with respect to the bottom plate and overlaying the holding parts in the state in which the sheet-like food unit is held in each of the first and the second holding parts.

7. The packed member according to claim 1, wherein the packaging container material holds the sheet-like food unit in each of holding parts by assembling a base sheet in which a frame plate is continuously formed to a lower edge of a main plate via a bottom plate, a lid plate is continuously formed to an upper edge of the main plate via a joining plate, a supporting plate is continuously formed to a left edge of the main plate via a side plate, a supporting plate is continuously formed to a right edge via a side plate, a supporting plate is continuously formed on a left edge of the frame plate via a side plate, and a supporting plate is continuously formed on a right edge via a side plate, to form a first holding part surrounded by the main plate, the side plates and the supporting plates, and a second holding part surrounded by the frame plate, the side plates and the supporting plates; continuously forming a fixing piece on each of the free end edges of the supporting plates via a fragile part, at an overlaying position with the joining base sheet of the sheet-like food unit held in the holding part; and further fixing the sheet-like food unit to each of the supporting plates at the joining base sheet.

8. The packed member according to claim 7, wherein front and back two rows of the sheet-like food are held in the holding parts in the state that the sheet-like food unit is held in each of the first and the second holding parts by making the main plate and the frame plate stand up with respect to the bottom plate and overlaying the holding parts and fixing the joining base sheet of the sheet-like food unit held in the first holding part with the fixing piece of the second holding part facing therewith.

9. A method of producing a packed member, comprising:
(i) an individual wrapping step of individually wrapping each of plural pieces of sheet-like food with a wrapping sheet which includes a picking part, a fixing part, and a fragile part between the both parts and is openable by cutting the fragile part and taking out the picking part;
(ii) an aligning step of aligning the individually wrapped plural pieces of sheet-like food close to each other in their width direction;
(iii) a unit forming step of forming a sheet-like food unit by placing and fixing the joining base sheet on at least one surface of the fixing part of each wrapping sheet of the aligned plural pieces of sheet-like food;
(iv) a placing step of placing the sheet-like food unit on a main plate of a packaging container material in which a frame plate is formed continuously to a lower edge of the main plate via a bottom plate, a lid plate is formed continuously to an upper edge of the main plate via a joining plate, a supporting plate is formed continuously to a left edge of the main plate via a side plate, and a supporting plate is formed continuously to a right edge of the main plate via a side plate, so that the joining base sheet is positioned on the bottom plate side;
(v) a holding step of surrounding the sheet-like food unit by folding the side plates, the supporting plates, the bottom plate and the frame plate with respect to the main plate, and fixing the frame plate to the supporting plates;
(vi) a fixing step of fixing the sheet-like food unit to at least one of the main plate, the side plates, the supporting plates, the bottom plate and the frame plate at the joining base sheet; and
(vii) an overlaying step of making the frame plate and the lid plate overlay each other by folding the joining plate and the lid plate with respect to the main plate.

10. A method of producing a packed member, comprising the steps of: placing a plurality of sheet-like food units on the main plate of the packaging container material in an overlaying manner so that the joining base sheet is positioned on the bottom plate side, and fixing each of the plurality of sheet-like food units to at least one of the main plate, the side plates, the supporting plates, the bottom plate, the frame plate and the other sheet-like food unit.

11. A method of producing a packed member, comprising the steps of:
(i) an individual wrapping step of individually wrapping each of plural pieces of sheet-like food with a wrapping sheet which includes a picking part, a fixing part, and a fragile part between the both parts and is openable by cutting the fragile part and taking out the picking part;
(ii) an aligning step of aligning the individually wrapped plural pieces of sheet-like food close to each other in their width direction;
(iii) a unit forming step of forming a sheet-like food unit by placing and fixing a joining base sheet on an upper surface of the fixing part of each wrapping sheet of the plural pieces of sheet-like food;
(iv) a placing step of placing on a base sheet wherein a first sheet-like food unit is placed on a frame plate of the base sheet of a packaging container material so that the joining base sheet is located on a bottom plate side and a second sheet-like food unit is placed on a main plate of the base sheet of the packaging container material so that the joining base sheet is located on the bottom plate side, the base sheet being configured by continuously forming the frame plate to a lower edge of the main plate via the bottom plate, continuously forming a lid plate to an upper edge of the main plate via a joining plate, continuously forming a supporting plate to a left edge of the main plate via a side plate, continuously forming a supporting plate to a right edge via a side plate, forming a supporting plate on a left edge of the frame plate via a side plate, and forming a supporting plate on a right edge via a side plate;
(v) a fixing step of fixing supporting plates by folding each of the supporting plates and fixing their inner surfaces to an upper surface of the joining base sheet of each of the sheet-like food units on the main plate and the frame plate; and
(vi) an overlaying step of overlaying a first holding part formed by being surrounded by the main plate, the side plates and the supporting plates and a second holding part formed being surrounded by the frame plate, the side plates and the supporting plates.

12. A method of producing a packed member, comprising the steps of:
(i) an individual wrapping step of individually wrapping each of plural pieces of sheet-like food with a wrapping sheet which includes a picking part, a fixing part and a fragile part between the both parts and is openable by cutting the fragile part and taking out the picking part;
(ii) an aligning step of aligning the individually wrapped plural pieces of sheet-like food close to each other in their width direction;
(iii) a unit forming step of forming a sheet-like food unit by placing and fixing a joining base sheet on an upper surface of the fixing part of each wrapping sheet of the plural pieces of sheet-like food;
(iv) a placing step of placing on a base sheet wherein a first sheet-like food unit is placed on a frame plate of the base sheet of a packaging container material so that the joining base sheet is located on a bottom plate side and a second sheet-like food unit is placed on a main plate of the base sheet of the packaging container material so that the joining base sheet is located on the bottom plate side, the base sheet being configured by continuously forming the frame plate to a lower edge of the main plate via the bottom plate, continuously forming a lid plate to an upper edge of the main plate via a joining plate, continuously forming a supporting plate to a left edge of the main plate via a side plate, continuously forming a supporting plate to a right edge via a side plate, forming a supporting plate on a left edge of the frame plate via a side plate, forming a supporting plate on a right edge via a side plate, and continuously forming a fixing piece on a respective free end edge of each of the supporting plates via a fragile part;
(v) a fixing step of fixing supporting plates by folding each of the supporting plates and fixing their inner surfaces to an upper surface of the joining base sheet of each of the sheet-like food units on the main plate and the frame plate; and
(vi) an overlaying step of overlaying a first holding part formed by being surrounded by the main plate, the side plates and the supporting plates and a second holding part formed by being surrounded by the frame plate, the side plates and the supporting plates, and fixing each fixing piece on the second holding part side and the joining base sheet of the sheet-like food unit held in the first holding part facing therewith.

13. The packed member according to claim 2, wherein a plurality of sheet-like food units are held in an overlaying manner.

14. The packed member according to claim 3, wherein a plurality of sheet-like food units are held in an overlaying manner.
